(19) United States
(12) Patent Application Publication
(10) Pub. No.: US 2023/0258447 A1
(43) Pub. Date: Aug. 17, 2023

(54) CALCULATION DEVICE, SURFACE ROUGHNESS PREDICTION SYSTEM, AND CALCULATION METHOD

(71) Applicant: FANUC CORPORATION, Yamanashi (JP)

(72) Inventors: Tomoki SHIMIZU, Yamanashi-ken (JP); Yonpyo HON, Yamanashi-ken (JP)

(21) Appl. No.: 18/025,871

(22) PCT Filed: Sep. 13, 2021
(86) PCT No.: PCT/JP2021/033468

§ 371 Date: Mar. 10, 2023

(30) Foreign Application Priority Data
Sep. 17, 2020 (JP) 2020-156217

(51) Int. Cl. G01B 21/30

(52) U.S. Cl. CPC G01B 21/30

(57) ABSTRACT

This calculation device for predicting the surface roughness of a processed product from a physical quantity includes: a measurement data acquisition unit which acquires measurement data of surface roughness measured by a surface roughness measuring device; a physical quantity acquisition unit which acquires a physical quantity indicating a factor that causes surface roughness; a first amplitude spectrum conversion unit which converts the measurement data into a first amplitude spectrum; a second amplitude spectrum conversion unit which converts the physical quantity into a second amplitude spectrum; and a coefficient calculation unit which calculates a coefficient on the basis of a specific frequency, the second amplitude spectrum, and the first amplitude spectrum.

### TECHNICAL FIELD

The present invention relates to a computation device (calculation device), a surface roughness prediction system, and a computation method (calculation method) which are used to predict a surface roughness of a workpiece machined by a machine tool.

### BACKGROUND ART

In JP 2018-189582 A, one example of a measurement device (hereinafter, referred to as a surface roughness measurement device) is disclosed which measures the surface roughness of a workpiece machined by a machine tool.

### SUMMARY OF THE INVENTION

In the field of machine tools, inspection of the surface roughness of a workpiece that is machined by a machine tool is carried out. In such an inspection, the machined surface roughness of a test piece is measured by experimentally machining the test piece prior to carrying out actual machining. In accordance therewith, the machined surface roughness of the test piece is evaluated. However, the surface roughness of the test piece is greatly affected by factors unrelated to the performance of the machine tool, such as tool wear or the accuracy of the setup and arrangements made by the operator and the like. Accordingly, merely by measuring the surface roughness of the test piece, it has been difficult to accurately predict the surface roughness of a workpiece that will thereafter be machined as a product.

Thus, the present invention has the object of providing a computation device, a surface roughness prediction system, and a computation method, which are capable of predicting the surface roughness of a workpiece.

A first aspect of the present invention is characterized by a computation device, including a measurement data acquisition unit configured to acquire measurement data measured by a surface roughness measurement device, the measurement data indicating a surface roughness of a workpiece machined by a machine tool, a physical quantity acquisition unit configured to acquire a physical quantity indicating a cause of occurrence of the surface roughness that, during machining by the machine tool, occurs in the workpiece depending on performance of the machine tool, a first amplitude spectrum conversion unit configured to perform frequency analysis on the measurement data and to convert the measurement data into a first amplitude spectrum, a second amplitude spectrum conversion unit configured to perform frequency analysis on the physical quantity and to convert the physical quantity into a second amplitude spectrum, and a coefficient calculation unit configured to calculate a coefficient that makes a result obtained by multiplying, by the coefficient, an amplitude value of the second amplitude spectrum at a specified frequency which is a predetermined frequency or a predetermined frequency band, equal, within a predetermined range, to an amplitude value of the first amplitude spectrum at the specified frequency, in order to predict the surface roughness of the workpiece from the physical quantity.

A second aspect of the present invention is characterized by a surface roughness prediction system equipped with the computation device according to the first aspect, and a surface roughness prediction device configured to predict the surface roughness of the workpiece machined by the machine tool using the specified frequency and the coefficient, the surface roughness prediction device including a physical quantity acquisition unit configured to acquire a physical quantity indicating a cause of occurrence of a surface roughness that, during machining by the machine tool, occurs in the workpiece depending on performance of the machine tool, an amplitude spectrum conversion unit configured to perform frequency analysis on the physical quantity and to convert the physical quantity into an amplitude spectrum, a storage unit configured to store the coefficient and the specified frequency, a surface roughness spectrum calculation unit configured to calculate a surface roughness amplitude spectrum indicating the surface roughness of the workpiece, by multiplying an amplitude value of the amplitude spectrum at the specified frequency and the coefficient, and a surface roughness calculation unit configured to calculate prediction data indicating the surface roughness of the workpiece by inversely transforming the surface roughness amplitude spectrum.

A third aspect of the present invention is characterized by a computation method, including a measurement data acquisition step of acquiring measurement data measured by a surface roughness measurement device, the measurement data indicating a surface roughness of a workpiece machined by a machine tool, a physical quantity acquisition step of acquiring a physical quantity indicating a cause of occurrence of the surface roughness that, during machining by the machine tool, occurs in the workpiece depending on performance of the machine tool, a first amplitude spectrum conversion step of performing frequency analysis on the measurement data and converting the measurement data into a first amplitude spectrum, a second amplitude spectrum conversion step of performing frequency analysis on the physical quantity acquired in the physical quantity acquisition step and converting the physical quantity into a second amplitude spectrum, and a coefficient calculation step of calculating a coefficient that makes a result obtained by multiplying, by the coefficient, an amplitude value of the second amplitude spectrum at a specified frequency which is a predetermined frequency or a predetermined frequency band, equal, within a predetermined range, to an amplitude value of the first amplitude spectrum at the specified frequency, in order to predict the surface roughness of the workpiece from the physical quantity.

According to the present invention, the computation device, the surface roughness prediction system, and the computation method are provided, which are capable of predicting the surface roughness of a workpiece.

### BRIEF DESCRIPTION OF THE DRAWINGS

FIG. 1 is a schematic configuration diagram of a surface roughness prediction system according to an embodiment;

FIG. 2 is a schematic configuration diagram of a computation device according to an embodiment;

FIG. 3 is a graph illustrating measurement data acquired by a measurement data acquisition unit;

FIG. 4 is a graph illustrating a physical quantity acquired by a physical quantity acquisition unit;

FIG. 5 is a graph illustrating a first amplitude spectrum calculated by a first amplitude spectrum conversion unit;

FIG. 6 is a graph illustrating a second amplitude spectrum calculated by a second amplitude spectrum conversion unit;

FIG. 7 is a flowchart illustrating a process flow of a computation method according to an embodiment;

FIG. 8 is a schematic configuration diagram of a surface roughness prediction device according to an embodiment;

FIG. 9A is a graph illustrating a third amplitude spectrum;

FIG. 9B is a graph illustrating a surface roughness amplitude spectrum calculated on the basis of the third amplitude spectrum shown in FIG. 9A;

FIG. 10 is a graph illustrating prediction data of the surface roughness of a workpiece which is calculated by a surface roughness calculation unit;

FIG. 11 is a flowchart illustrating a process flow of a surface roughness prediction method of a workpiece according to an embodiment;

FIG. 12A is a graph showing a first example of a spectrum calculated by a surface roughness spectrum calculation unit according to an Exemplary Modification 4;

FIG. 12B is a graph showing a second example of a spectrum calculated by the surface roughness spectrum calculation unit according to the Exemplary Modification 4;

FIG. 12C is a graph illustrating a surface roughness amplitude spectrum calculated by the surface roughness spectrum calculation unit according to the Exemplary Modification 4; and

FIG. 13 is a schematic configuration diagram of a computation device according to an Exemplary Modification 6.

### DETAILED DESCRIPTION OF THE INVENTION

A description will be presented in detail below with reference to the accompanying drawings which set forth suitable embodiments concerning a computation unit, a surface roughness prediction system, and a computation method according to the present invention.

### Embodiment

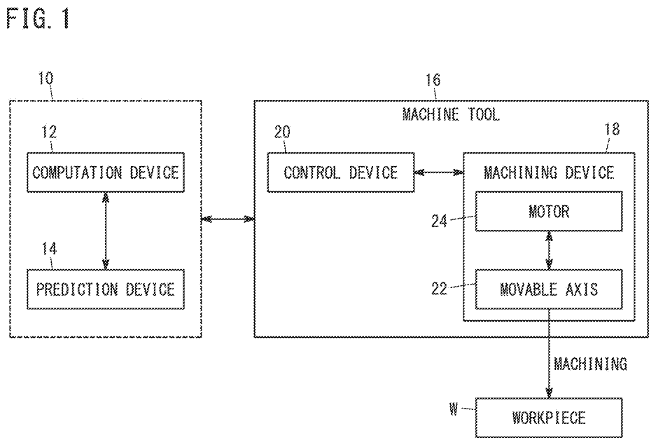

FIG. 1 is a schematic configuration diagram of a surface roughness prediction system 10 according to an embodiment.

FIG. 1 shows a machine tool 16 as well as the surface roughness prediction system 10. In the following, the machine tool 16 will first be described. The surface roughness prediction system 10 of FIG. 1 will be described while taking into consideration a description of the machine tool 16.

The machine tool 16, for example, is an industrial machine which is controlled by a CNC (Computerized Numerical Control) system. The machine tool 16 carries out machining of an object to be machined (a workpiece) using a tool. In accordance therewith, the machine tool 16 produces a workpiece W. A specific example of the machine tool 16, for example, is an ultra-high precision machine tool. The ultra-high precision machine tool carries out machining with a resolution of less than or equal to 10 nanometers, in accordance with commands having a command resolution thereof. It should be noted that the machine tool 16 is not limited to being an ultra-high precision machine tool.

The machine tool 16 is shown schematically in FIG. 1. The machine tool 16 includes a machining device 18 and a control device 20. The machining device 18 is a machine that carries out machining using tools. The machining device 18 includes at least one movable axis 22 and a motor 24. The movable axis 22 is capable of being driven during execution of machining. A motor 24 serves as a drive source for the movable axis 22. The movable axis 22 is provided, for example, in order to move a table that supports the object to be machined along a predetermined direction. The movable axis 22 causes the tool of the machine tool 16 to be moved relative to the object to be machined that is supported on the table, in accordance with driving of the motor 24.

The control device 20 is an electronic device that controls (numerically controls) the machining device 18. The control device 20 is equipped with a processor and a memory, neither of which are shown. A predetermined program for controlling the machining device 18 is stored in the memory of the control device 20. The processor of the control device 20 executes the program. In accordance with this feature, the processor functions in order to control the machining device 18. The control device 20, for example, controls driving of the aforementioned motor 24. Consequently, the control device 20 controls the driving of the movable axis 22. For example, based on the rotational position of the motor 24, the control device 20 calculates a positional deviation PQ_{pd} of the movable axis 22. The positional deviation PQ_{pd} indicates a deviation between a commanded position of the movable axis 22 and the actual position of the movable axis 22. Further, based on the calculated positional deviation PQ_{pd} of the movable axis 22, the control device 20 controls the position (and movement) of the movable axis 22. Moreover, the rotational position of the motor 24 can be detected, for example, by providing a rotary encoder in the motor 24.

The surface roughness prediction system 10 according to the present embodiment, for example, is a system that predicts the surface roughness of the workpiece W manufactured by the aforementioned machine tool 16. The surface roughness prediction system 10, as shown in FIG. 1, is connected to the machine tool 16. The surface roughness prediction system 10 comprises a computation device 12 and a surface roughness prediction device (hereinafter, simply referred to as a “prediction device”) 14. Each of the computation device 12 and the prediction device 14 is provided in the form of an electronic device (a computer) according to the present embodiment. The computation device 12 and the prediction device 14 are connected so as to be capable of communicating with each other.

Of the computation device 12 and the prediction device 14, the prediction device 14 predicts the surface roughness of the workpiece W that is machined by the machine tool 16. The prediction device 14 predicts the surface roughness of the workpiece W on the basis of a physical quantity PQ and a predetermined coefficient (hereinafter, simply referred to as a “coefficient”) C. The physical quantity PQ is acquired from the machine tool 16. The coefficient C is determined in accordance with the type of the physical quantity PQ. A more detailed description of each of the physical quantity PQ, the coefficient C, and the prediction device 14 will be presented later.

The physical quantity PQ used by the prediction device 14 for predicting the surface roughness is numerical information indicating a cause of occurrence of the surface roughness of the workpiece W in the case that the machine tool 16 carries out machining of the workpiece W. The causes of occurrence of the surface roughness of the workpiece W vary depending on the performance of the machine tool 16. To give a specific example of the physical quantity PQ, for example, the aforementioned positional deviation PQ_{pd} of the movable axis 22 may be cited. More specifically, the deviation, which occurs during machining, between the commanded position of the movable axis 22 and the actual position of the movable axis 22 is one of the causes of occurrence of the surface roughness.

The coefficient C used by the prediction device 14 to predict the surface roughness is a numerical value that makes the result obtained by multiplying an amplitude value of an amplitude spectrum of the physical quantity PQ at a specified frequency FB and the coefficient C equal, within a predetermined range, to an amplitude value of an amplitude spectrum of the surface roughness of the workpiece W at the specified frequency FB. The specified frequency FB is a frequency determined in advance in accordance with the type of the physical quantity PQ. The specified frequency FB may be a frequency band that is determined in advance in accordance with the type of the physical quantity PQ. Details concerning the specified frequency FB will be described later.

The computation device 12 calculates the above-described coefficient C. The computation device 12 calculates the coefficient C on the basis of the physical quantity PQ and the surface roughness of the workpiece W. The physical quantity PQ is acquired in the case that the machine tool 16 actually carries out machining of the workpiece W. A more detailed description concerning the computation device 12 will be presented later.

A brief functional overview of the aforementioned surface roughness prediction system 10 is as follows. In the surface roughness prediction system 10, at first, the computation device 12 calculates the coefficient C. The coefficient C is calculated based on a machining result of a test piece that is experimentally machined. The coefficient C is calculated prior to machining of the workpiece W whose surface roughness is to be predicted. The coefficient C is calculated in accordance with the type of the physical quantity PQ. Next, the prediction device 14 converts the physical quantity PQ into an amplitude spectrum. The physical quantity PQ is acquired by machining the workpiece W whose surface roughness is to be predicted. The prediction device 14 multiplies the amplitude value of the amplitude spectrum at the specified frequency FB and the coefficient C. The result of multiplying the amplitude value of the amplitude spectrum of the physical quantity PQ at the specified frequency FB and the coefficient C indicates a prediction value of the amplitude spectrum of the surface roughness of the workpiece W at the specified frequency FB. On the basis of the result of multiplying the amplitude spectrum of the physical quantity PQ at the specified frequency FB and the coefficient C, the prediction device 14 predicts the surface roughness of the workpiece W at the specified frequency FB.

The configuration and the overview of the surface roughness prediction system 10 are as described above. Next, based on the above description, the configuration of the computation device 12 and the configuration of the prediction device 14 will be described in that order. The computation device 12 calculates the coefficient C. The prediction device 14 predicts the surface roughness based on the coefficient C and the physical quantity PQ.

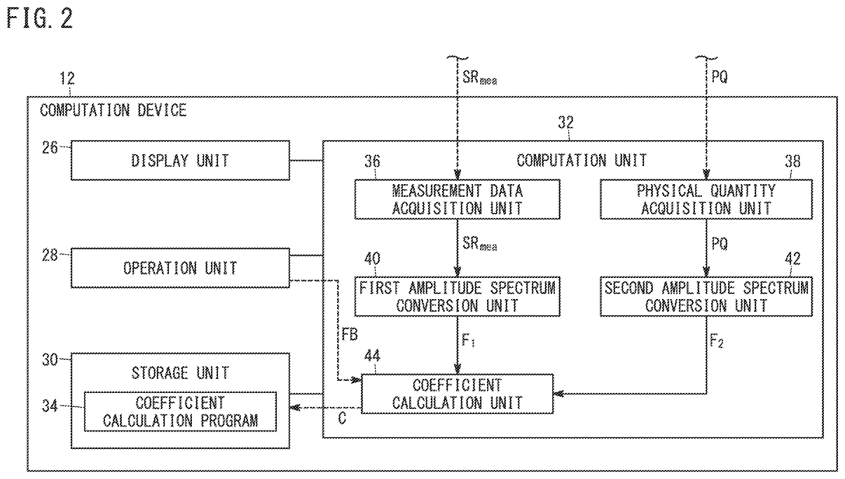

FIG. 2 is a schematic configuration diagram of the computation device 12 according to the embodiment.

As shown in FIG. 2, the computation device 12 is equipped with a display unit 26, an operation unit (input unit) 28, a storage unit 30, and a computation unit 32.

The display unit 26 enables the computation device 12 to display information. The display unit 26 is configured, for example, by a display having a liquid crystal display screen. However, the display screen is not limited to being a liquid crystal display screen. The display screen may also be, for example, an organic EL (OEL: Organic Electro-Luminescence) screen.

The operation unit 28 is constituted, for example, by a keyboard and a mouse. However, the operation unit 28 is not limited to having a keyboard and a mouse. The operation unit 28 may include, for example, a touch panel provided on the display screen of the aforementioned display unit 26. The operation unit 28 enables the operator of the machine tool 16 to input information (instructions) to the computation device 12. In particular, the operation unit 28 according to the present embodiment enables the operator to input the aforementioned specified frequency FB to the computation device 12.

The storage unit 30 enables the computation device 12 to store information. The storage unit 30 is configured by a memory including, for example, a RAM (Random Access Memory) and a ROM (Read Only Memory). Information obtained in a process of calculating the coefficient C by the computation device 12 is appropriately stored as necessary in the storage unit 30.

Further, as shown in FIG. 2, a coefficient calculation program 34 is stored in advance in the storage unit 30. The coefficient calculation program 34 is a predetermined program created in advance in order to allow the computation device 12 to calculate the coefficient C.

The computation unit 32 enables the computation device 12 to arithmetically process information. The computation unit 32 is constituted by a processor including, for example, a CPU (Central Processing Unit) and a GPU (Graphics Processing Unit). The computation unit 32 is capable of reading and executing the coefficient calculation program 34 that is stored in the storage unit 30.

As further shown in FIG. 2, the computation unit 32 is equipped with a measurement data acquisition unit 36, a physical quantity acquisition unit 38, a first amplitude spectrum conversion unit 40, a second amplitude spectrum conversion unit 42, and a coefficient calculation unit 44. Each of these units that are provided in the computation unit 32 is virtually realized by the computation unit 32 executing the coefficient calculation program 34.

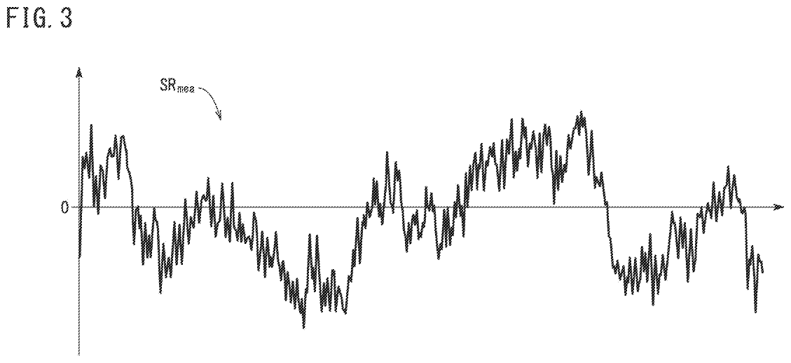

The measurement data acquisition unit 36 acquires measurement data SRₘₑₐ. Consequently, the computation device 12 obtains the graph as shown in FIG. 3, for example. The measurement data SRₘₑₐ indicates the surface roughness of the workpiece W machined by the machine tool 16. The measurement data SRₘₑₐ is measured by a non-illustrated surface roughness measurement device. For example, a known type of surface roughness measurement device is used as the surface roughness measurement device. The measurement data acquisition unit 36 acquires the measurement data SRₘₑₐ from the surface roughness measurement device.

FIG. 3 is a graph illustrating the measurement data SRₘₑₐ that is acquired by the measurement data acquisition unit 36. In the graph of FIG. 3, the horizontal axis represents time. Further, in the graph of FIG. 3, the vertical axis represents the roughness of the machined surface. The reference of the vertical axis (“0” in FIG. 3) is a reference plane.

Moreover, it should be noted that the surface roughness measurement device is not limited to being the device disclosed in JP 2018-189582 A. The measurement data SRₘₑₐ is measured by experimentally machining a test workpiece (test piece), and measuring the surface roughness of the workpiece (test piece) W that has been machined. Hereinafter, in order to distinguish between the workpieces, the workpiece (the test workpiece) W that serves as a measurement target of the measurement data SRₘₑₐ may be referred to as a “first workpiece W₁”. Further, the workpiece W whose surface roughness is to be predicted by the prediction device 14 may be referred to as a “second workpiece W₂”. However, in the case that there is no particular need to distinguish between the first workpiece W₁ and the second workpiece W₂, both of them are simply referred to as a “workpiece W”. The measurement data SRₘₑₐ is measured prior to the second workpiece W₂ being subjected to machining.

The physical quantity acquisition unit 38 acquires the physical quantity PQ which indicates the cause of the surface roughness that occurs in the first workpiece W₁ depending on the performance of the machine tool 16 in the case that the first workpiece W₁ is subjected to machining by the machine tool 16.

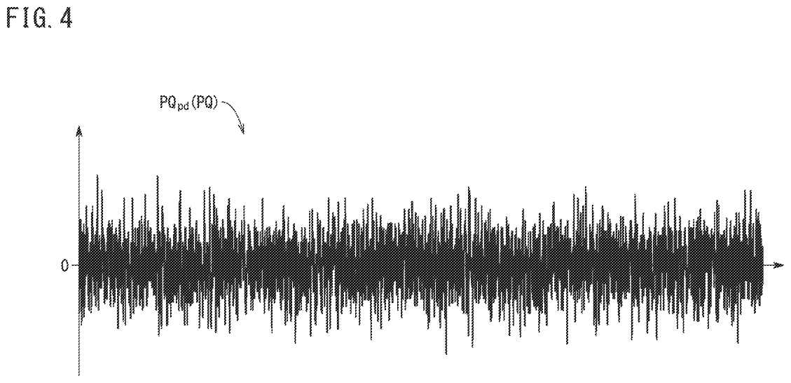

FIG. 4 is a graph illustrating the physical quantity PQ acquired by the physical quantity acquisition unit 38. In the graph of FIG. 4, the horizontal axis represents time. Further, in the graph of FIG. 4, the vertical axis represents the positional deviation PQ_{pd}. The reference of the vertical axis (“0” in FIG. 4) is the commanded position of the movable axis 22.

The type of the physical quantity PQ acquired by the physical quantity acquisition unit 38 is the same as the type of the physical quantity PQ used by the prediction device 14 in order to predict the surface roughness. The type of the physical quantity PQ may be determined in advance by a careful examination made by the operator. As an example, in the present embodiment, the physical quantity acquisition unit 38 acquires the positional deviation PQ_{pd} of the movable axis 22. Consequently, the computation device 12 obtains the graph as shown in FIG. 4, for example. The positional deviation PQ_{pd} of the movable axis 22 can be obtained from the control device 20 of the machine tool 16, as described previously.

The physical quantity acquisition unit 38 acquires the positional deviation PQ_{pd} in the case that the first workpiece W₁ is actually machined by the machine tool 16 in the above-described manner. In this instance, in the case that the machine tool 16 is equipped with a plurality of movable axes 22, it is preferable that the machining performed by the machine tool 16 be carried out with as few of the movable axes 22 as possible during machining. Ideally, the number of the movable axes 22 driven during machining is one. As the type of machining carried out by a single-axis drive, there may be cited the following type of machining, although the present invention is not limited to this type. More specifically, machining is carried out in which, from among the plurality of movable axes 22 of the machine tool 16, by driving only a movable axis 22 that moves, in one direction, a table with the first workpiece W₁ supported thereon, a cut is made in the first workpiece W₁.

The machining of the first workpiece W₁ is carried out in order for the physical quantity acquisition unit 38 to acquire the positional deviation PQ_{pd}. By machining of the first workpiece W₁ being carried out by driving as few of the movable axes 22 as possible, noise components that are mixed in the positional deviation PQ_{pd} acquired by the physical quantity acquisition unit 38 are reduced. The noise components are generated due to movable axes 22 other than the movable axis 22 for which the positional deviation PQ_{pd} is to be detected (calculated) being driven.

The first amplitude spectrum conversion unit 40 performs frequency analysis on the measurement data SRₘₑₐ acquired by the measurement data acquisition unit 36. Consequently, the first amplitude spectrum conversion unit 40 converts the measurement data SRₘₑₐ into an amplitude spectrum. Hereinafter, the amplitude spectrum calculated by the first amplitude spectrum conversion unit 40 based on frequency analysis may also be referred to as a first amplitude spectrum F₁.

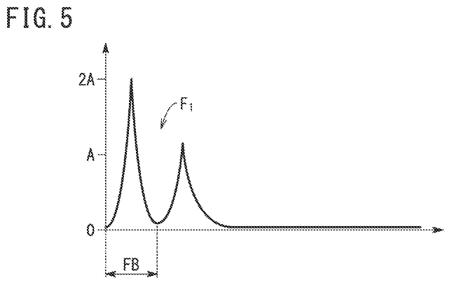

FIG. 5 is a graph illustrating the first amplitude spectrum F₁ calculated by the first amplitude spectrum conversion unit 40. In the graph of FIG. 5, the horizontal axis represents frequency. Further, in the graph of FIG. 5, the vertical axis represents an amplitude value (decibels (dB)).

The first amplitude spectrum F₁ shown in FIG. 5 represents an amplitude spectrum of the surface roughness of the first workpiece W₁. Moreover, FB in FIG. 5 is an example of the above-described specified frequency FB.

The first amplitude spectrum conversion unit 40 converts the measurement data SRₘₑₐ into the first amplitude spectrum F₁ by way of frequency analysis which is based on a Fourier transform, for example. Moreover, it should be noted that, although a Fourier transform has simply been described, more specifically, the first amplitude spectrum conversion unit 40 may appropriately use, for example, a short-time Fourier transform or a discrete Fourier transform. Alternatively, the first amplitude spectrum conversion unit 40 may calculate the first amplitude spectrum F₁ using a wavelet transform.

The second amplitude spectrum conversion unit 42 performs frequency analysis on the physical quantity PQ acquired by the physical quantity acquisition unit 38. Consequently, the second amplitude spectrum conversion unit 42 converts the physical quantity PQ into an amplitude spectrum. Hereinafter, the amplitude spectrum calculated by the second amplitude spectrum conversion unit 42 based on frequency analysis may also be referred to as a second amplitude spectrum F₂.

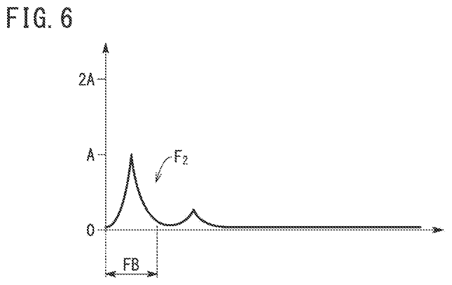

FIG. 6 is a graph illustrating the second amplitude spectrum F₂ calculated by the second amplitude spectrum conversion unit 42. The graph of FIG. 6 is of the same format as the graph of FIG. 5.

In the case of the present embodiment, the second amplitude spectrum F₂ shown in FIG. 6 represents an amplitude spectrum of the positional deviation PQ_{pd} of the movable axis 22. The specified frequency FB shown in FIG. 6 indicates the same frequency band as that of the specified frequency FB shown in FIG. 5.

The second amplitude spectrum conversion unit 42 converts the positional deviation PQ_{pd} of the movable axis 22 into the second amplitude spectrum F₂ by way of frequency analysis which is based on a Fourier transform, for example. Moreover, it should be noted that, although a Fourier transform has simply been described, more specifically, the second amplitude spectrum conversion unit 42 may appropriately use a short-time Fourier transform or a discrete Fourier transform. Alternatively, the second amplitude spectrum conversion unit 42 may calculate the second amplitude spectrum F₂ using a wavelet transform.

The coefficient calculation unit 44 calculates the coefficient C. The coefficient C makes the multiplication result obtained by multiplying the amplitude value of the second amplitude spectrum F₂ at the specified frequency FB and the coefficient C equal, within a predetermined range, to the amplitude value of the first amplitude spectrum F₁ at the specified frequency FB. The calculated coefficient C is temporarily stored in the storage unit 30, in a manner so that the prediction device 14 is thereafter capable of acquiring the coefficient C. The predetermined range is an allowable error range in the case that the multiplication result of multiplying the second amplitude spectrum F₂ and the coefficient C does not coincide numerically with the first amplitude spectrum F₁. The predetermined range is determined based on a prior careful examination.

An example of a calculation made by the coefficient calculation unit 44 will next be described. For example, the amplitude value of the first amplitude spectrum F₁ at the specified frequency FB is assumed to be 2A decibels. Further, the amplitude value of the second amplitude spectrum F₂ at the specified frequency FB is assumed to be A decibels. In this case, the coefficient calculation unit 44 calculates “2” as being the coefficient C. The number “2” is a number which, by being multiplied by the amplitude value (=A) of the second amplitude spectrum F₂, derives the amplitude value (=2A) of the first amplitude spectrum F₁.

Moreover, in the case that the specified frequency FB is determined as a frequency band, the coefficient C can be calculated for each of a plurality of frequencies included within the specified frequency FB. In such a case, it is sufficient for the coefficient calculation unit 44 to calculate the coefficient C for one of the frequencies within the specified frequency FB. For example, the coefficient calculation unit 44 may calculate the coefficient C, in which the multiplication result of multiplying a maximum value of the amplitude of the second amplitude spectrum F₂ at the specified frequency FB and the coefficient C is equal, within a predetermined range, to the amplitude value of the first amplitude spectrum F₁ at a frequency corresponding to the maximum value. In this case, at frequencies other than the frequency used to calculate the coefficient C at the specified frequency FB, the multiplication result of multiplying the amplitude value of the second amplitude spectrum F₂ and the coefficient C may not coincide with the amplitude value of the first amplitude spectrum F₁. In such a case, it is sufficient if the error between the multiplication result and the amplitude value of the first amplitude spectrum F₁ lies within a range allowed by the aforementioned range.

In this instance, the specified frequency FB will be described once again. For example, in a certain frequency band (or at a certain frequency), the surface roughness of the workpiece W is caused to occur primarily due to vibrations of the movable axis 22. Alternatively, in another frequency band (or at another frequency), the surface roughness of the workpiece W is caused to occur primarily due to fluctuations in the pressure received by a bearing of the movable axis 22. Accordingly, only one single specified frequency FB is determined for one type of the physical quantity PQ. In this case, the specified frequency FB indicates a frequency or a frequency band in which the cause of occurrence of the surface roughness of the workpiece W indicated by the physical quantity PQ has a dominant influence on the occurrence of the surface roughness. For example, in each of FIG. 5 and FIG. 6, the specified frequency FB is shown that exemplify a frequency band in which the positional deviation PQ_{pd} of the movable axis 22 (positional shifting of the movable axis 22) has a dominant influence on the occurrence of surface roughness.

The aforementioned specified frequency FB is determined by a careful examination made by the operator in advance. For example, taking into account the following items, the operator performs the careful examination to determine the frequency as being the specified frequency FB, or the frequency band as being the specified frequency FB. More specifically, the operator, for example, performs the careful examination in light of the installation environment of the machine tool 16, the component parts included in the machine tool 16, the degree of wear of the tool of the machine tool 16, and the type of physical quantity PQ to be acquired by the computation device 12.

The operator inputs the carefully examined frequency or frequency band into the computation device 12 via the operation unit 28. The computation device 12 receives the input operation of the frequency or the frequency band input made by the operator, and uses the frequency or the frequency band that was input as the specified frequency FB.

An exemplary configuration of the computation device 12 has been described above. Next, a description will be given of a process flow of a computation method of the coefficient C which is executed by the computation device 12.

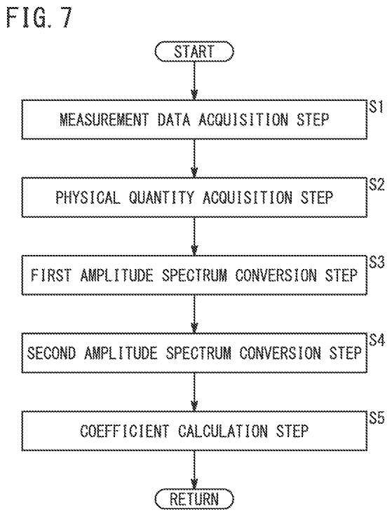

FIG. 7 is a flowchart illustrating a process flow of the computation method according to the embodiment.

As shown in FIG. 7, the computation method of the coefficient C includes a measurement data acquisition step S1, a physical quantity acquisition step S2, a first amplitude spectrum conversion step S3, a second amplitude spectrum conversion step S4, and a coefficient calculation step S5.

In the measurement data acquisition step S1, the measurement data acquisition unit 36 acquires the measurement data SRₘₑₐ. The measurement data SRₘₑₐ indicates the surface roughness of the workpiece W that is machined by the machine tool 16, which is measured by the surface roughness measurement device.

In the physical quantity acquisition step S2, the physical quantity acquisition unit 38 acquires the physical quantity PQ. The physical quantity PQ indicates the cause of occurrence of the surface roughness that, during machining by the machine tool 16, occurs in the workpiece W depending on the performance of the machine tool 16. In this instance, the workpiece W is the first workpiece W₁.

It should be noted that the execution order of the measurement data acquisition step S1 and the physical quantity acquisition step S2 by the computation device 12 is not limited to what is shown in the flowchart of FIG. 7. The execution order of the measurement data acquisition step S1 and the physical quantity acquisition step S2 may be reversed.

In the first amplitude spectrum conversion step S3, the first amplitude spectrum conversion unit 40 performs frequency analysis on the measurement data SRₘₑₐ. Consequently, the first amplitude spectrum conversion unit 40 converts the measurement data SRₘₑₐ into the first amplitude spectrum F₁.

In the second amplitude spectrum conversion step S4, the second amplitude spectrum conversion unit 42 performs frequency analysis on the physical quantity PQ. Consequently, the second amplitude spectrum conversion unit 42 converts the physical quantity PQ into the second amplitude spectrum F₂.

In the coefficient calculation step S5, the coefficient C is calculated by the coefficient calculation unit 44. The coefficient C makes the multiplication result obtained by multiplying the amplitude value of the second amplitude spectrum F₂ at the specified frequency FB and the coefficient C equal, within the predetermined range, to the amplitude value of the first amplitude spectrum F₁ at the specified frequency FB.

The computation device 12 calculates the coefficient C by executing the above-described computation method. Next, a description will be given concerning the configuration of the prediction device 14 that predicts the surface roughness of the second workpiece W₂, using the coefficient C calculated by the computation device 12.

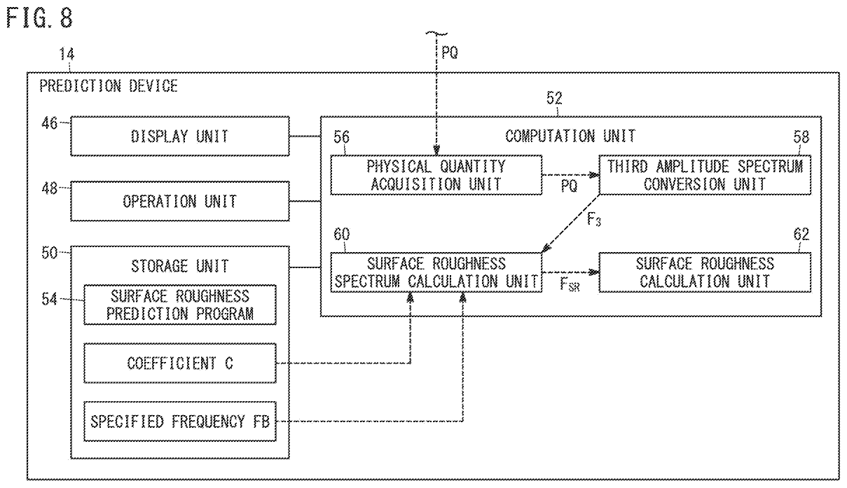

FIG. 8 is a schematic configuration diagram of the surface roughness prediction device 14 according to the embodiment.

As shown in FIG. 8, the prediction device 14 is equipped with a display unit 46, an operation unit 48, a storage unit 50, and a computation unit 52.

The display unit 46 enables the prediction device 14 to display information. The display unit 46 is configured, for example, by a display having a liquid crystal display screen. The display screen of the display unit 46 of the prediction device 14 is not limited to being a liquid crystal display screen.

The operation unit 48 is constituted, for example, by a keyboard and a mouse. However, the operation unit 48 is not limited to having a keyboard and a mouse. The operation unit 48 enables the operator to input information (instructions) to the prediction device 14.

The storage unit 50 enables the prediction device 14 to store information. The storage unit 50 is configured by a memory including, for example, a RAM and a ROM. As shown in FIG. 8, a surface roughness prediction program 54 is stored in advance in the storage unit 50. The surface roughness prediction program 54 is a predetermined program prepared in advance in order for the prediction device 14 to carry out the prediction of the surface roughness.

Further, the coefficient C and the specified frequency FB are stored in the storage unit 50. The coefficient C and the specified frequency FB can be acquired from the aforementioned computation device 12.

The computation unit 52 enables the prediction device 14 to arithmetically process information. The computation unit 52 is constituted by a processor including, for example, a CPU and a GPU. The computation unit 52 is capable of reading and executing the surface roughness prediction program 54 that is stored in the storage unit 50.

As further shown in FIG. 8, the computation unit 52 is equipped with a physical quantity acquisition unit 56, a third amplitude spectrum conversion unit (amplitude spectrum conversion unit) 58, a surface roughness spectrum calculation unit 60, and a surface roughness calculation unit 62. Each of these units that are provided in the computation unit 52 is virtually realized by the computation unit 52 executing the surface roughness prediction program 54.

The physical quantity acquisition unit 56 acquires the physical quantity PQ. The physical quantity PQ indicates the cause of occurrence of the surface roughness that, during machining by the machine tool 16, occurs in the second workpiece W₂ depending on the performance of the machine tool 16. The type of the physical quantity PQ is the same as the type of the physical quantity PQ used by the computation device 12 in order to calculate the coefficient C. For example, in the case of the present embodiment, the physical quantity acquisition unit 56 acquires the positional deviation PQ_{pd} of the movable axis 22 of the machine tool 16.

The third amplitude spectrum conversion unit 58 performs frequency analysis on the physical quantity PQ acquired by the physical quantity acquisition unit 56. Consequently, the third amplitude spectrum conversion unit 58 converts the physical quantity PQ into an amplitude spectrum. Hereinafter, the amplitude spectrum calculated by the third amplitude spectrum conversion unit 58 based on frequency analysis may also be referred to as a third amplitude spectrum F₃. In the case of the present embodiment, the third amplitude spectrum F₃ represents an amplitude spectrum of the positional deviation PQ_{pd} of the movable axis 22 in the case that the second workpiece W₂ is subjected to machining.

The third amplitude spectrum conversion unit 58 converts the positional deviation PQ_{pd} of the movable axis 22 into the third amplitude spectrum F₃ by way of frequency analysis which is based on a Fourier transform, for example. Moreover, it should be noted that, although a Fourier transform has simply been described, more specifically, the third amplitude spectrum conversion unit 58 may appropriately use a short-time Fourier transform or a discrete Fourier transform. Alternatively, the third amplitude spectrum conversion unit 58 may calculate the third amplitude spectrum F₃ using a wavelet transform.

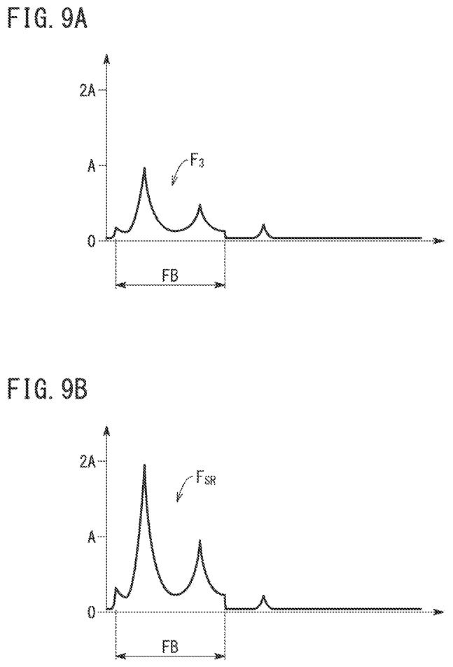

FIG. 9A is a graph illustrating the third amplitude spectrum F₃. FIG. 9B is a graph illustrating a surface roughness amplitude spectrum F_{SR} calculated on the basis of the third amplitude spectrum F₃ shown in FIG. 9A. Each of the graph of FIG. 9A and the graph of FIG. 9B is of the same format as the graph of FIG. 5.

The surface roughness spectrum calculation unit 60 multiplies the amplitude value of the third amplitude spectrum F₃ at the specified frequency FB and the coefficient C. Consequently, the surface roughness spectrum calculation unit 60 calculates the surface roughness amplitude spectrum F_{SR}. For example, it is assumed that the third amplitude spectrum F₃ of the positional deviation PQ_{pd} of the movable axis 22 is as shown in FIG. 9A. Further, it is assumed that the specified frequency FB at which the positional deviation PQ_{pd} of the movable axis 22 becomes the primary cause for the occurrence of surface roughness is as shown in FIG. 9A. The coefficient C calculated by the computation device 12 so as to correspond to the positional deviation PQ_{pd} of the movable axis 22 is assumed to be “2”. In this case, the surface roughness spectrum calculation unit 60 calculates the surface roughness amplitude spectrum F_{SR} shown in FIG. 9B. The amplitude value at the specified frequency FB of the surface roughness amplitude spectrum F_{SR} shown in FIG. 9B is twice the amplitude value of the third amplitude spectrum F₃ shown in FIG. 9A at the specified frequency FB.

In the case of there being no change in the installation environment of the machine tool 16, the component parts included in the machine tool 16, and the degree of wear of the tool of the machine tool 16, the amplitude value of the surface roughness amplitude spectrum F_{SR} does not significantly differ from the amplitude value of the surface roughness amplitude spectrum of the second workpiece W₂ at the specified frequency FB. Thus, according to the present embodiment, the surface roughness amplitude spectrum F_{SR} serves as a prediction value of the surface roughness amplitude spectrum of the second workpiece W₂.

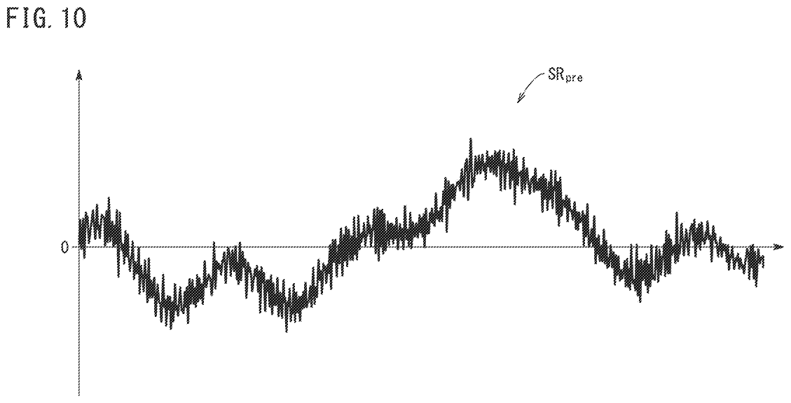

FIG. 10 is a graph illustrating prediction data SRₚᵣₑ of the surface roughness of the workpiece W which is calculated by the surface roughness calculation unit 62. The graph of FIG. 10 is of the same format as the graph of FIG. 3.

The surface roughness calculation unit 62 inversely transforms the surface roughness amplitude spectrum F_{SR}. Consequently, the surface roughness calculation unit 62 calculates the prediction data SRₚᵣₑ. The prediction data SRₚᵣₑ indicates the surface roughness of the second workpiece W₂. In the case that a Fourier transform is used by the third amplitude spectrum conversion unit 58 at the time of calculating the third amplitude spectrum F₃, the inverse transform in this instance indicates an inverse Fourier transform. Further, in the case that a wavelet transform is used by the third amplitude spectrum conversion unit 58 at the time of calculating the third amplitude spectrum F₃, the inverse transform in this instance indicates an inverse wavelet transform. Consequently, the surface roughness calculation unit 62 obtains the prediction data SRₚᵣₑ, for example, as shown in FIG. 10.

As noted previously, the surface roughness amplitude spectrum F_{SR} serves as the prediction value of the surface roughness amplitude spectrum of the second workpiece W₂ at the specified frequency FB. Accordingly, the result of inversely transforming the surface roughness amplitude spectrum F_{SR} as calculated by the surface roughness calculation unit 62 becomes the prediction data SRₚᵣₑ of the surface roughness of the second workpiece W₂ at the specified frequency FB. The surface roughness prediction data SRₚᵣₑ is output to the display unit 46, for example, by the computation unit 52 (the surface roughness calculation unit 62). Consequently, the prediction data SRₚᵣₑ is shown to the operator via the display screen of the display unit 46.

An exemplary configuration of the prediction device 14 has been described above. Next, a description will be given of the process flow of the surface roughness prediction method executed by the prediction device 14.

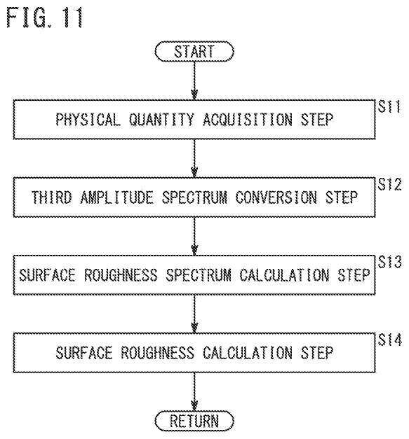

FIG. 11 is a flowchart illustrating the process flow of the surface roughness prediction method of the workpiece W according to the embodiment.

As shown in FIG. 11, the surface roughness prediction method includes a physical quantity acquisition step S11, a third amplitude spectrum conversion step S12, a surface roughness spectrum calculation step S13, and a surface roughness calculation step S14.

In the physical quantity acquisition step S11, the physical quantity acquisition unit 56 acquires the physical quantity PQ. The physical quantity PQ indicates the cause of occurrence of the surface roughness that, during machining by the machine tool 16, occurs in the workpiece W depending on the performance of the machine tool 16. In this instance, the workpiece W is the second workpiece W₂.

In the third amplitude spectrum conversion step S12, the third amplitude spectrum conversion unit 58 performs frequency analysis on the physical quantity PQ. Consequently, the third amplitude spectrum conversion unit 58 converts the physical quantity PQ into the third amplitude spectrum F₃. The physical quantity PQ in this instance is the physical quantity PQ of the second workpiece W₂. The physical quantity PQ of the second workpiece W₂ is acquired by executing the above-described physical quantity acquisition step S11.

In the surface roughness spectrum calculation step S13, the surface roughness spectrum calculation unit 60 calculates the surface roughness amplitude spectrum F_{SR}. The surface roughness amplitude spectrum F_{SR} is calculated by multiplying the amplitude value of the third amplitude spectrum F₃ at the specified frequency FB and the coefficient C. The surface roughness amplitude spectrum F_{SR} indicates the surface roughness of the workpiece W.

In the surface roughness calculation step S14, the surface roughness calculation unit 62 calculates the prediction data SRₚᵣₑ. The prediction data SRₚᵣₑ indicates the surface roughness of the workpiece W. The prediction data SRₚᵣₑ is calculated by inversely transforming the surface roughness amplitude spectrum F_{SR}. The prediction device 14 predicts the surface roughness of the second workpiece W₂ by executing the above-described surface roughness prediction method.

As noted previously, according to the present embodiment, the computation device 12, the surface roughness prediction system 10, the computation method, and the surface roughness prediction method are provided, which are capable of predicting the surface roughness of the workpiece W.

### EXEMPLARY MODIFICATIONS

The embodiment has been described above as one example of the present invention. Various modifications or improvements are capable of being added to the above-described embodiment. It is also apparent from the scope of the claims that embodiments to which such modifications and improvements are added may be incorporated in the technical scope of the invention.

Hereinafter, some specific examples of the exemplary modifications according to the embodiment will be described. However, elements that have already been described in relation to the present embodiment are provided with the same names and reference numerals as in the embodiment. Further, descriptions of the elements that have already been described in relation to the embodiment may be omitted.

### Exemplary Modification 1

According to the present exemplary modification, a case will be described in which the machine tool 16 is the ultra-high precision machine tool. The physical quantity acquisition unit 56 of the prediction device 14 may acquire the physical quantity PQ detected at a time when the ultra-high precision machine tool is operating with no workpiece. The third amplitude spectrum conversion unit 58 may convert such a physical quantity PQ into the third amplitude spectrum F₃. The surface roughness spectrum calculation unit 60 may calculate the surface roughness amplitude spectrum F_{SR} on the basis of the third amplitude spectrum F₃.

In the case that the machine tool 16 is the ultra-high precision machine tool, it is unlikely for a significant difference to occur between the physical quantity PQ detected in the case that the machine tool 16 has carried out machining of the workpiece W, and the physical quantity PQ in the case that the machine tool 16 has carried out operating with no workpiece. For example, in machining with a resolution of less than or equal to 10 nanometers that is performed in accordance with commands having a command resolution of less than or equal to 10 nanometers, the cutting resistance of the tool that cuts the workpiece W is extremely small. Accordingly, as compared to another type of the machine tool 16, in the ultra-high precision machine tool, a large difference normally does not occur between the positional deviation PQ_{pd} detected in the case that the ultra-high precision machine tool has machined the workpiece W, and the positional deviation PQ_{pd} detected in the case that the ultra-high precision machine tool has operated with no workpiece. It should be noted that the term “operating with no workpiece” implies that the operation at the time of machining by the machine tool 16 is carried out without an object to be machined.

Accordingly, in the case that the machine tool 16 is an ultra-high precision machine tool, and if the coefficient C and the specified frequency FB are determined, the prediction device 14 is capable of predicting the surface roughness of the second workpiece W₂ without actually carrying out machining of the second workpiece W₂ using the ultra-high precision machine tool.

### Exemplary Modification 2

The prediction device 14 may receive, via the operation unit (the coefficient changing unit) 48, an operation to change the coefficient C made by the operator. In accordance with this feature, for example, in the case that the operator desires to adjust the coefficient C by himself/herself, it is possible to conveniently enable the operator to make such an adjustment.

In the aforementioned case, for example, based on the predetermined range noted previously, the prediction device 14 may limit the range in which the coefficient C is capable of being changed. The aforementioned predetermined range is a range that the coefficient calculation unit 44 refers to at the time when the coefficient C is calculated.

### Exemplary Modification 3

The physical quantity PQ used by the prediction device 14 for predicting the surface roughness is not limited to being the positional deviation PQ_{pd} of the movable axis 22. For example, each of the temperature of the movable axis 22, the straightness of the movable axis 22, a bearing fluid (oil) pressure of the movable axis 22, a bearing air pressure of the movable axis 22, a bearing fluid (oil) temperature or a bearing air temperature, and the temperature of the cutting fluid used during machining corresponds to the physical quantity PQ. Further, the temperature of the cutting fluid used for machining (the temperature of the cutting fluid inside a storage tank) also corresponds to the physical quantity PQ. These physical quantities PQ can be acquired from sensors that are appropriately provided in the machine tool 16. For example, each of the computation device 12 and the prediction device 14 can acquire the hydraulic pressure or the air pressure of the bearing of the movable axis 22 from a pressure sensor provided on the movable axis 22. Further, each of the computation device 12 and the prediction device 14 is capable of acquiring the temperature of the movable axis 22 from a temperature sensor.

### Exemplary Modification 4

The present exemplary modification will be described in relation to the Exemplary Modification 3. The computation device 12 and the prediction device 14 may acquire a plurality of types of the physical quantities PQ.

First, the computation device 12 according to the present exemplary modification will be described. The physical quantity acquisition unit 38 of the computation device 12 may acquire the plurality of types of the physical quantities PQ. Each of the plurality of types of the physical quantities PQ indicates the cause of occurrence of the surface roughness that, during machining by the machine tool 16, occurs in the workpiece W depending on the performance of the machine tool 16. In this case, the number of the causes of occurrence is a plurality. As described in the present embodiment, the specified frequency FB is determined in advance for each of the types of the physical quantities PQ. Accordingly, in the case of the present modification, the number of the specified frequencies FB is a plurality, which corresponds to the number of the types of the physical quantities PQ. The plurality of the specified frequencies FBs are of different frequencies or different frequency bands from each other.

Further, the coefficient calculation unit 44 of the computation device 12 calculates a plurality of the coefficients C. The plurality of the coefficients C correspond to respective specified frequencies FB that are different from each other. Consequently, based on the plurality of types of the physical quantities PQ, the surface roughness of the workpiece W is predicted. More specifically, the coefficient calculation unit 44 according to the present exemplary modification calculates, for each of the specified frequencies FB, a coefficient C that makes the multiplication result obtained by multiplying the amplitude value of the second amplitude spectrum F₂ at the specified frequency FB and the coefficient C equal, within the predetermined range, to the amplitude value of the first amplitude spectrum F₁ at the specified frequency FB.

Consequently, the computation device 12 is capable of calculating the coefficients C corresponding respectively to the plurality of types of the physical quantities PQ (the plurality of the specified frequencies FB).

Next, the prediction device 14 according to the present exemplary modification will be described. The physical quantity acquisition unit 56 of the prediction device 14 may acquire the plurality of types of the physical quantities PQ. Each of the plurality of types of the physical quantities PQ indicates the cause of occurrence of the surface roughness that, during machining by the machine tool 16, occurs in the workpiece W depending on the performance of the machine tool 16. In this case, the number of the causes of occurrence is a plurality. The storage unit 50 of the prediction device 14 stores the coefficients C corresponding respectively to the plurality of the specified frequencies FB. In this case, the number of the coefficients C stored in the storage unit 50 is a plurality.

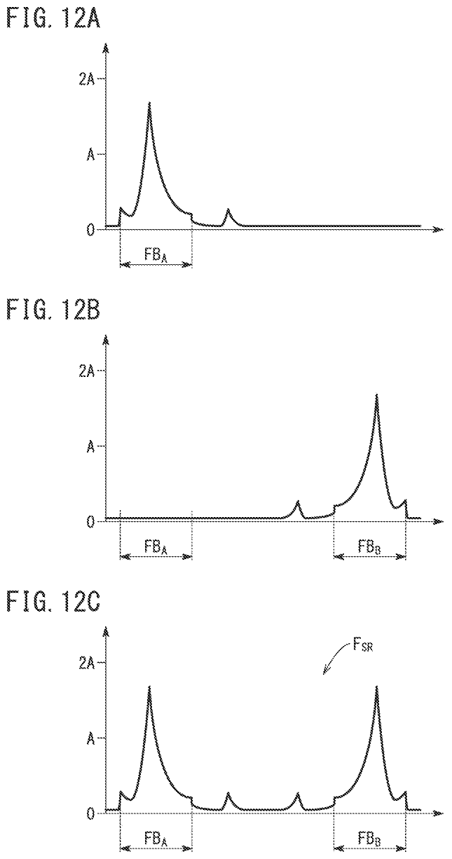

FIG. 12A is a graph showing a first example of a spectrum calculated by the surface roughness spectrum calculation unit 60 according to the Exemplary Modification 4. FIG. 12B is a graph showing a second example of a spectrum calculated by the surface roughness spectrum calculation unit 60 according to the Exemplary Modification 4. Each of the graph of FIG. 12A and the graph of FIG. 12B is of the same format as the graph of FIG. 5.

In the present exemplary modification, for each of the plurality of the specified frequencies FB, the surface roughness spectrum calculation unit 60 multiplies the amplitude value of the third amplitude spectrum F₃ corresponding to the specified frequency FB and the coefficient C corresponding to the specified frequency FB. Consequently, a plurality of spectra are calculated by the surface roughness spectrum calculation unit 60 (for example, refer to each of FIG. 12A and FIG. 12B). FIG. 12A illustrates a spectrum obtained by multiplying the amplitude value of the third amplitude spectrum F₃ at the specified frequency FB_{A} by the coefficient C corresponding to the specified frequency FB_{A}. FIG. 12B illustrates a spectrum obtained by multiplying the amplitude value of the third amplitude spectrum F₃ at the specified frequency FB_{B} by the coefficient C corresponding to the specified frequency FB_{B}. The third amplitude spectrum F₃ shown in FIG. 12A and the third amplitude spectrum F₃ shown in FIG. 12B are based on mutually different types of the physical quantities PQ.

FIG. 12C is a graph illustrating a surface roughness amplitude spectrum F_{SR} calculated by the surface roughness spectrum calculation unit 60 according to the Exemplary Modification 4.

Further, the surface roughness spectrum calculation unit 60 adds the plurality of spectra. Consequently, the surface roughness spectrum calculation unit 60 calculates the surface roughness amplitude spectrum F_{SR}. In this instance, the plurality of spectra to be added are calculated by multiplying the amplitude value of the third amplitude spectrum F₃ and the coefficient C, for each of the plurality of the specified frequencies FB. For example, the surface roughness spectrum calculation unit 60 adds the spectrum shown in FIG. 12A and the spectrum shown in FIG. 12B. Consequently, the surface roughness amplitude spectrum F_{SR} as shown in FIG. 12C is calculated.

The surface roughness calculation unit 62 inversely transforms the surface roughness amplitude spectrum F_{SR} that was calculated. Consequently, the surface roughness calculation unit 62 calculates the surface roughness prediction data SRₚᵣₑ. The prediction data SRₚᵣₑ calculated in the manner described above is data obtained by taking into account the plurality of the specified frequencies FB (the plurality of types of the physical quantities PQ). Accordingly, in comparison with the embodiment, the prediction data SRₚᵣₑ according to the present exemplary modification can be expected to predict the surface roughness of the second workpiece W₂ with higher accuracy.

### Exemplary Modification 5

The surface roughness prediction system 10 may be applied to a shape accuracy prediction system that predicts an accuracy in the shape of the workpiece W (the second workpiece W₂). That is, the shape accuracy prediction system may predict the accuracy in the shape of the workpiece W on the basis of the surface roughness predicted by the surface roughness prediction system 10.

### Exemplary Modification 6

The computation device 12 may be configured to serve in a dual manner as the prediction device 14. Hereinafter, a description will be given of an example of such a computation device 12. Moreover, according to the present exemplary modification, the physical quantity acquisition unit 38 is also referred to as a physical quantity acquisition unit 64 for the sake of convenience and in order to distinguish it from the embodiment. Further, the second amplitude spectrum conversion unit 42 is also referred to as a second amplitude spectrum conversion unit 66 for the sake of convenience. For the same reason, the storage unit 30 of the computation device 12 is also referred to as a storage unit 30′. Further, the computation unit 32 of the computation device 12 is also referred to as a computation unit 32′.

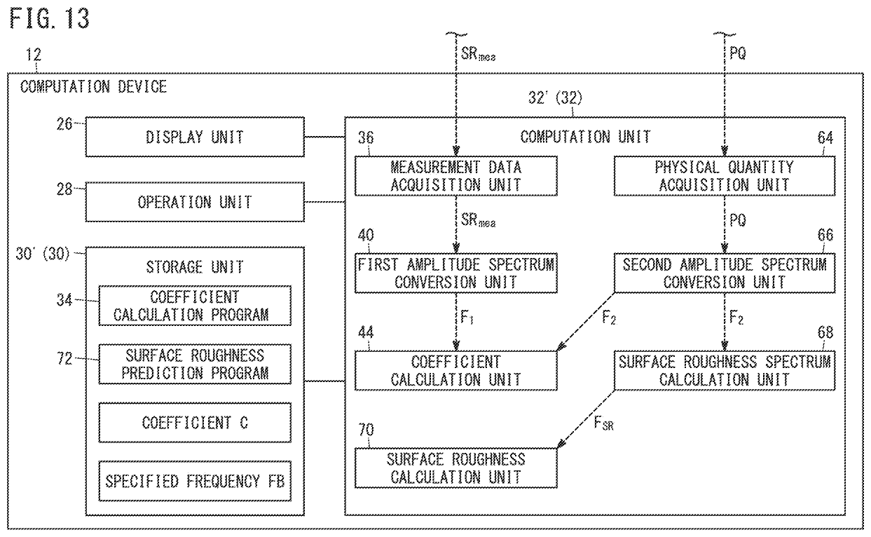

FIG. 13 is a schematic configuration diagram of a computation device 12 according to the Exemplary Modification 6.

The computation unit 32′ of the computation device 12 is further equipped with a surface roughness spectrum calculation unit 68 and a surface roughness calculation unit 70 according to the present exemplary modification (refer to FIG. 13). The surface roughness spectrum calculation unit 68 and the surface roughness calculation unit 70 are each virtually realized by a surface roughness prediction program 72 being executed by the computation unit 32′. The surface roughness prediction program 72 is a predetermined program prepared in advance in order for the prediction of the surface roughness to be performed by the computation device 12. The surface roughness prediction program 72 is stored beforehand in the storage unit 30′.

In calculating the coefficient C, the physical quantity acquisition unit 64 acquires the physical quantity PQ of the first workpiece W₁. Further, in predicting the surface roughness of the second workpiece W₂, the physical quantity acquisition unit 64 acquires the physical quantity PQ of the second workpiece W₂. The physical quantity acquisition unit 64 differs from the physical quantity acquisition unit 38 of the embodiment, in that it acquires the physical quantity PQ of the second workpiece W₂.

In calculating the coefficient C, the second amplitude spectrum conversion unit 66 converts the physical quantity PQ of the first workpiece W₁ into the second amplitude spectrum F₂. In predicting the surface roughness of the second workpiece W₂, the second amplitude spectrum conversion unit 66 converts the physical quantity PQ of the second workpiece W₂ into the second amplitude spectrum F₂. The second amplitude spectrum conversion unit 66 differs from the second amplitude spectrum conversion unit 42 of the embodiment, in that it converts the physical quantity PQ of the second workpiece W₂ into the second amplitude spectrum F₂.

The surface roughness spectrum calculation unit 68 multiplies the amplitude value of the second amplitude spectrum F₂ of the physical quantity PQ at the specified frequency FB and the coefficient C. Consequently, the surface roughness spectrum calculation unit 68 calculates the surface roughness amplitude spectrum F_{SR} indicating the surface roughness of the workpiece W. It is noted that the second amplitude spectrum F₂ referred to in this instance is an amplitude spectrum obtained by converting the physical quantity PQ in the case that the second workpiece W₂ is subjected to machining. That is, after the coefficient C has been calculated by the coefficient calculation unit 44, the surface roughness spectrum calculation unit 68 calculates the surface roughness amplitude spectrum F_{SR} from the second amplitude spectrum F₂, which is obtained by converting the physical quantity PQ acquired by machining the second workpiece W₂.

The surface roughness calculation unit 70 inversely transforms the surface roughness amplitude spectrum F_{SR} calculated by the surface roughness spectrum calculation unit 68. Consequently, the surface roughness calculation unit 70 calculates the prediction data SRₚᵣₑ of the surface roughness of the second workpiece W₂. In this manner, according to the present exemplary modification, the computation device 12 becomes capable of carrying out not only the calculation of the coefficient C, but also the prediction of the surface roughness of the second workpiece W₂. That is to say, after having completed the computation method shown in FIG. 7, the surface roughness spectrum calculation unit 68 of the computation device 12 according to the present exemplary modification is capable of performing the surface roughness spectrum calculation step S13 shown in FIG. 11. Further, the surface roughness calculation unit 70 can perform the surface roughness calculation step S14.

### Exemplary Modification 7

It has been described above that the computation device 12 and the prediction device 14 can be configured together in an integrated manner. Further, the computation device 12 and the prediction device 14 may be configured as electronic devices integrated with the control device 20 of the machine tool 16.

### Exemplary Modification 8

The exemplary modifications described above may be combined as appropriate.

### Inventions that can be Obtained from the Embodiment

The inventions that can be grasped from the above-described embodiment and the modifications thereof will be described below.

### First Invention

The computation device (12) includes the measurement data acquisition unit (36) that acquires the measurement data (SRₘₑₐ) measured by the surface roughness measurement device, the measurement data indicating the surface roughness of the workpiece (W) machined by the machine tool (16), the physical quantity acquisition unit (38) that acquires the physical quantity (PQ) indicating the cause of occurrence of the surface roughness that, during machining by the machine tool, occurs in the workpiece depending on performance of the machine tool, the first amplitude spectrum conversion unit (40) that performs frequency analysis on the measurement data and converts the measurement data into the first amplitude spectrum (F₁), the second amplitude spectrum conversion unit (42, 66) that performs frequency analysis on the physical quantity and converts the physical quantity into the second amplitude spectrum (F₂), and the coefficient calculation unit (44) that calculates the coefficient (C) that makes a result obtained by multiplying, by the coefficient, an amplitude value of the second amplitude spectrum at a specified frequency (FB) which is a predetermined frequency or a predetermined frequency band, equal, within a predetermined range, to the amplitude value of the first amplitude spectrum at the specified frequency, in order to predict the surface roughness of the workpiece from the physical quantity.

In accordance with such features, the computation device is provided which is capable of predicting the surface roughness of the workpiece.

In the computation device, the physical quantity may be one of the positional deviation (PQ_{pd}) of the movable axis (22) that undergoes movement during machining by the machine tool, the temperature of the movable axis, the straightness of the movable axis, the fluid pressure or the air pressure in the bearing of the movable axis, the fluid temperature or the air temperature of the bearing, and the temperature of the cutting fluid used during machining.

In the first invention, there may further be provided the input unit (28) that receives the input operation of the frequency or the frequency band made by the operator, wherein the coefficient calculation unit may use the frequency or the frequency band input via the input unit, as the specified frequency. In accordance with this feature, the operator can cause the computation device to refer to the examined frequency or the examined frequency band as the specified frequency.

The first amplitude spectrum conversion unit may convert the measurement data into the first amplitude spectrum by way of frequency analysis which is based on a Fourier transform or a wavelet transform, and the second amplitude spectrum conversion unit may convert the physical quantity into the second amplitude spectrum by way of frequency analysis which is based on a Fourier transform or a wavelet transform.

The physical quantity acquisition unit may acquire the plurality of types of the physical quantities indicating a plurality of causes of occurrence of the surface roughness that, during machining by the machine tool, occurs in the workpiece depending on the performance of the machine tool, the plurality of the specified frequencies may be predetermined corresponding respectively to the plurality of types of the physical quantities, the plurality of the specified frequencies may have mutually different frequencies or mutually different frequency bands, and in order to predict the surface roughness of the workpiece from the plurality of types of the physical quantities, the coefficient calculation unit may serve to calculate the plurality of the coefficients corresponding respectively to the plurality of the specified frequencies, wherein a result obtained by multiplying the amplitude value of the second amplitude spectrum at each of the plurality of the specified frequencies by the corresponding one of the coefficients, is equal, within a predetermined range, to the amplitude value of the first amplitude spectrum at that of the plurality of the specified frequencies. In accordance with such features, the coefficient corresponding to each of the plurality of the specified frequencies can be calculated.

The first invention may further include the surface roughness spectrum calculation unit (68) that calculates the surface roughness amplitude spectrum (F_{SR}) indicating the surface roughness of the workpiece, by multiplying the coefficient and the amplitude value of the second amplitude spectrum at the specified frequency, and the surface roughness calculation unit (70) that calculates the prediction data (SRₚᵣₑ) indicating the surface roughness of the workpiece, by inversely transforming the surface roughness amplitude spectrum. In accordance with such features, it is possible to predict the surface roughness according to the first invention.

The first invention may further include the surface roughness spectrum calculation unit that calculates the surface roughness amplitude spectrum indicating the surface roughness of the workpiece, by adding a plurality of spectra each obtained by multiplying the amplitude value of the second amplitude spectrum at each of the plurality of the specified frequencies and the corresponding one of the coefficients which correspond respectively to the plurality of the specified frequencies, and the surface roughness calculation unit that calculates the prediction data indicating the surface roughness of the workpiece, by inversely transforming the surface roughness amplitude spectrum. In accordance with such features, the first invention is made capable of predicting the surface roughness based on the plurality of types of the physical quantities.

The machine tool may be an ultra-high precision machine tool that carries out machining with a resolution of less than or equal to 10 nanometers in accordance with a command having a command resolution of less than or equal to 10 nanometers, and after the coefficient has been calculated by the coefficient calculation unit, the surface roughness spectrum calculation unit may calculate the surface roughness amplitude spectrum from the second amplitude spectrum that has been generated by the second amplitude spectrum conversion unit from the physical quantity detected at a time when the ultra-high precision machine tool is operating with no workpiece. In accordance with such features, if the coefficient has already been calculated, the first invention is capable of predicting the surface roughness of the workpiece, even if a workpiece whose surface roughness is to be predicted is not actually machined.

The first invention may further include the coefficient changing unit (48) that receives an operation to change the coefficient made by the operator, wherein, in the case that the operator has changed the coefficient, the surface roughness spectrum calculation unit may multiply the amplitude value of the second amplitude spectrum at the specified frequency and the changed coefficient, and may thereby calculate the surface roughness amplitude spectrum indicating the surface roughness of the workpiece. In accordance with such features, convenience for the operator can be achieved.

### Second Invention

The surface roughness prediction system (10) is equipped with the first invention, and the surface roughness prediction device (14) which predicts the surface roughness of the workpiece machined by the machine tool using the specified frequency and the coefficient, the surface roughness prediction device including the physical quantity acquisition unit (56) that acquires the physical quantity indicating the cause of occurrence of the surface roughness that, during machining by the machine tool, occurs in the workpiece depending on performance of the machine tool, the amplitude spectrum conversion unit (58) which performs frequency analysis on the physical quantity and converts the physical quantity into the amplitude spectrum, the storage unit (50) that stores the coefficient and the specified frequency, the surface roughness spectrum calculation unit (60) which calculates the surface roughness amplitude spectrum (F_{SR}) indicating the surface roughness of the workpiece, by multiplying the amplitude value of the amplitude spectrum at the specified frequency and the coefficient, and the surface roughness calculation unit (62) that calculates the prediction data (SRₚᵣₑ) indicating the surface roughness of the workpiece by inversely transforming the surface roughness amplitude spectrum.

In accordance with such features, the surface roughness prediction system is provided which is capable of predicting the surface roughness of the workpiece.

The physical quantity acquisition unit of the surface roughness prediction device may acquire a plurality of types of the physical quantities indicating a plurality of causes of occurrence of the surface roughness that, during machining by the machine tool, occurs in the workpiece depending on the performance of the machine tool, the plurality of the specified frequencies may be determined beforehand corresponding respectively to the plurality of types of the physical quantities, the plurality of the specified frequencies may have mutually different frequencies or mutually different frequency bands, the storage unit may store the plurality of coefficients that correspond respectively to the plurality of specified frequencies, and the surface roughness spectrum calculation unit may calculate the surface roughness amplitude spectrum, by adding a plurality of spectra each obtained by multiplying the amplitude value of the amplitude spectrum at each of the plurality of the specified frequencies and a corresponding one of the coefficients which correspond respectively to the plurality of the specified frequencies. In accordance with such features, it becomes possible to predict the surface roughness based on the plurality of types of the physical quantities.

The machine tool (16) may be the ultra-high precision machine tool that carries out machining with a resolution of less than or equal to 10 nanometers in accordance with a command having a command resolution of less than or equal to 10 nanometers, and the physical quantity acquisition unit of the surface roughness prediction device may acquire the physical quantity detected at a time when the ultra-high precision machine tool is operating with no workpiece. In accordance with such features, if the coefficient has already been calculated, the second invention is capable of predicting the surface roughness of the workpiece, even if a workpiece whose surface roughness is to be predicted is not actually machined.

The second invention may further include the coefficient changing unit (48) that receives an operation to change the coefficient made by the operator, wherein, in the case that the operator has changed the coefficient, the surface roughness spectrum calculation unit multiplies the amplitude value of the second amplitude spectrum at the specified frequency and the changed coefficient, and may thereby calculate the surface roughness amplitude spectrum indicating the surface roughness of the workpiece. In accordance with such features, convenience for the operator can be achieved.

### Third Invention

The computation method includes the measurement data acquisition step (S1) of acquiring the measurement data (SRₘₑₐ) measured by the surface roughness measurement device, the measurement data indicating the surface roughness of the workpiece (W) machined by the machine tool (16), the physical quantity acquisition step (S2) of acquiring the physical quantity (PQ) indicating the cause of occurrence of the surface roughness that, during machining by the machine tool, occurs in the workpiece depending on performance of the machine tool, the first amplitude spectrum conversion step (S3) of performing frequency analysis on the measurement data and converting the measurement data into the first amplitude spectrum (F₁), the second amplitude spectrum conversion step (S4) of performing frequency analysis on the physical quantity acquired in the physical quantity acquisition step and converting the physical quantity into the second amplitude spectrum (F₂), and the coefficient calculation step (S5) of calculating the coefficient (C) that makes a result obtained by multiplying, by the coefficient, an amplitude value of the second amplitude spectrum at a specified frequency (FB) which is a predetermined frequency or a predetermined frequency band, equal, within a predetermined range, to an amplitude value of the first amplitude spectrum at the specified frequency, in order to predict the surface roughness of the workpiece from the physical quantity.

In accordance with such features, the computation method is provided which is capable of predicting the surface roughness of the workpiece.

The third invention may further include the surface roughness spectrum calculation step (S13) of calculating the surface roughness amplitude spectrum (F_{SR}) indicating the surface roughness of the workpiece, by multiplying the coefficient and the amplitude value of the second amplitude spectrum at the specified frequency, and the surface roughness calculation step (S14) of calculating the prediction data (SRₚᵣₑ) indicating the surface roughness of the workpiece by inversely transforming the surface roughness amplitude spectrum. In accordance with such features, it is possible to predict the surface roughness according to the third invention.

1. A computation device, comprising:
a measurement data acquisition unit configured to acquire measurement data measured by a surface roughness measurement device, the measurement data indicating a surface roughness of a workpiece machined by a machine tool;
a physical quantity acquisition unit configured to acquire a physical quantity indicating a cause of occurrence of the surface roughness that, during machining by the machine tool, occurs in the workpiece depending on performance of the machine tool;
a first amplitude spectrum conversion unit configured to perform frequency analysis on the measurement data and to convert the measurement data into a first amplitude spectrum;
a second amplitude spectrum conversion unit configured to perform frequency analysis on the physical quantity and to convert the physical quantity into a second amplitude spectrum; and
a coefficient calculation unit configured to calculate a coefficient that makes a result obtained by multiplying, by the coefficient, an amplitude value of the second amplitude spectrum at a specified frequency which is a predetermined frequency or a predetermined frequency band, equal, within a predetermined range, to an amplitude value of the first amplitude spectrum at the specified frequency, in order to predict the surface roughness of the workpiece from the physical quantity.

2. The computation device according to claim 1, wherein the physical quantity is one of a positional deviation of a movable axis configured to undergo movement during machining by the machine tool, a temperature of the movable axis, a straightness of the movable axis, a fluid pressure or an air pressure in a bearing of the movable axis, a fluid temperature or an air temperature of the bearing, and a temperature of a cutting fluid used during machining.

3. The computation device according to claim 1, further comprising:
an input unit configured to receive an input operation of a frequency or a frequency band made by an operator,
wherein the coefficient calculation unit uses the frequency or the frequency band input via the input unit, as the specified frequency.

4. The computation device according to claim 1, wherein:
the first amplitude spectrum conversion unit converts the measurement data into the first amplitude spectrum by way of frequency analysis which is based on a Fourier transform or a wavelet transform, and
the second amplitude spectrum conversion unit converts the physical quantity into the second amplitude spectrum by way of frequency analysis which is based on a Fourier transform or a wavelet transform.

5. The computation device according to claim 1, wherein:
the physical quantity comprises a plurality of types of physical quantities indicating a plurality of causes of occurrence of the surface roughness that, during machining by the machine tool, occurs in the workpiece depending on the performance of the machine tool,
the physical quantity acquisition unit acquires the plurality of types of physical quantities,
the specified frequency comprises a plurality of specified frequencies that are predetermined corresponding respectively to the plurality of types of physical quantities,
the plurality of specified frequencies have mutually different frequencies or mutually different frequency bands, and
the coefficient comprises a plurality of coefficients, and in order to predict the surface roughness of the workpiece from the plurality of types of physical quantities, the coefficient calculation unit calculates the plurality of coefficients corresponding respectively to the plurality of specified frequencies, wherein a result obtained by multiplying an amplitude value of the second amplitude spectrum at each of the plurality of specified frequencies by a corresponding one of the coefficients, is equal, within a predetermined range, to an amplitude value of the first amplitude spectrum at that of the plurality of specified frequencies.

6. The computation device according to claim 1, further comprising:
a surface roughness spectrum calculation unit configured to calculate a surface roughness amplitude spectrum indicating the surface roughness of the workpiece, by multiplying the coefficient and the amplitude value of the second amplitude spectrum at the specified frequency; and
a surface roughness calculation unit configured to calculate prediction data indicating the surface roughness of the workpiece, by inversely transforming the surface roughness amplitude spectrum.

7. The computation device according to claim 5, further comprising:
a surface roughness spectrum calculation unit configured to calculate a surface roughness amplitude spectrum indicating the surface roughness of the workpiece, by adding a plurality of spectra each obtained by multiplying the amplitude value of the second amplitude spectrum at each of the plurality of specified frequencies and the corresponding one of the coefficients which correspond respectively to the plurality of specified frequencies; and
a surface roughness calculation unit configured to calculate prediction data indicating the surface roughness of the workpiece, by inversely transforming the surface roughness amplitude spectrum.

8. The computation device according to claim 6, wherein:
the machine tool is an ultra-high precision machine tool configured to carry out machining with a resolution of less than or equal to 10 nanometers in accordance with a command having a command resolution of less than or equal to 10 nanometers; and
after the coefficient has been calculated by the coefficient calculation unit, the surface roughness spectrum calculation unit calculates the surface roughness amplitude spectrum from the second amplitude spectrum that has been generated by the second amplitude spectrum conversion unit from the physical quantity detected at a time when the ultra-high precision machine tool is operating with no workpiece.

9. The computation device according to claim 6, further comprising:
a coefficient changing unit configured to receive an operation to change the coefficient made by an operator;
wherein, in a case that the operator has changed the coefficient, the surface roughness spectrum calculation unit multiplies the amplitude value of the second amplitude spectrum at the specified frequency and the changed coefficient, and thereby calculates the surface roughness amplitude spectrum indicating the surface roughness of the workpiece.

10. A surface roughness prediction system equipped with the computation device according to claim 1, and a surface roughness prediction device configured to predict the surface roughness of the workpiece machined by the machine tool using the specified frequency and the coefficient;
the surface roughness prediction device comprising:
a physical quantity acquisition unit configured to acquire a physical quantity indicating a cause of occurrence of the surface roughness that, during machining by the machine tool, occurs in the workpiece depending on the performance of the machine tool;
an amplitude spectrum conversion unit configured to perform frequency analysis on the physical quantity and to convert the physical quantity into an amplitude spectrum;
a storage unit configured to store the coefficient and the specified frequency;
a surface roughness spectrum calculation unit configured to calculate a surface roughness amplitude spectrum indicating the surface roughness of the workpiece, by multiplying an amplitude value of the amplitude spectrum at the specified frequency and the coefficient; and
a surface roughness calculation unit configured to calculate prediction data indicating the surface roughness of the workpiece by inversely transforming the surface roughness amplitude spectrum.

11. The surface roughness prediction system according to claim 10, wherein:
the physical quantity comprises a plurality of types of physical quantities indicating a plurality of causes of occurrence of the surface roughness that, during machining by the machine tool, occurs in the workpiece depending on the performance of the machine tool,
the physical quantity acquisition unit of the surface roughness prediction device acquires the plurality of types of physical quantities;
the specified frequency comprises a plurality of specified frequencies that are predetermined corresponding respectively to the plurality of types of physical quantities;
the plurality of specified frequencies have mutually different frequencies or mutually different frequency bands;
the coefficient comprises a plurality of coefficients that correspond respectively to the plurality of specified frequencies, and the storage unit stores the plurality of coefficients; and
the surface roughness spectrum calculation unit calculates the surface roughness amplitude spectrum, by adding a plurality of spectra each obtained by multiplying the amplitude value of the amplitude spectrum at each of the plurality of specified frequencies and a corresponding one of the coefficients which correspond respectively to the plurality of the specified frequencies.

12. The surface roughness prediction system according to claim 10, wherein:
the machine tool is an ultra-high precision machine tool configured to carry out machining with a resolution of less than or equal to 10 nanometers in accordance with a command having a command resolution of less than or equal to 10 nanometers; and
the physical quantity acquisition unit of the surface roughness prediction device acquires the physical quantity detected at a time when the ultra-high precision machine tool is operating with no workpiece.

13. The surface roughness prediction system according to claim 10, further comprising:
a coefficient changing unit configured to receive an operation to change the coefficient made by an operator,
wherein, in a case that the operator has changed the coefficient, the surface roughness spectrum calculation unit multiplies the amplitude value of the second amplitude spectrum at the specified frequency and the changed coefficient, and thereby calculates the surface roughness amplitude spectrum indicating the surface roughness of the workpiece.

14. A computation method, comprising:
a measurement data acquisition step of acquiring measurement data measured by a surface roughness measurement device, the measurement data indicating a surface roughness of a workpiece machined by a machine tool;
a physical quantity acquisition step of acquiring a physical quantity indicating a cause of occurrence of the surface roughness that, during machining by the machine tool, occurs in the workpiece depending on performance of the machine tool;
a first amplitude spectrum conversion step of performing frequency analysis on the measurement data and converting the measurement data into a first amplitude spectrum;
a second amplitude spectrum conversion step of performing frequency analysis on the physical quantity acquired in the physical quantity acquisition step and converting the physical quantity into a second amplitude spectrum; and
a coefficient calculation step of calculating a coefficient that makes a result obtained by multiplying, by the coefficient, an amplitude value of the second amplitude spectrum at a specified frequency which is a predetermined frequency or a predetermined frequency band, equal, within a predetermined range, to an amplitude value of the first amplitude spectrum at the specified frequency, in order to predict the surface roughness of the workpiece from the physical quantity.

15. The computation method according to claim 14, further comprising:
a surface roughness spectrum calculation step of calculating a surface roughness amplitude spectrum indicating the surface roughness of the workpiece, by multiplying the coefficient and the amplitude value of the second amplitude spectrum at the specified frequency; and
a surface roughness calculation step of calculating prediction data indicating the surface roughness of the workpiece, by inversely transforming the surface roughness amplitude spectrum.
